(19) United States
(12) Patent Application Publication
(10) Pub. No.: US 2022/0058361 A1
(43) Pub. Date: Feb. 24, 2022

(54) TOPOLOGICAL STRUCTURE LIGHT SOURCE DRIVING METHOD, STORAGE MEDIUM AND ELECTRONIC DEVICE APPLIED TO OFF SCREEN IMAGING

(71) Applicant: SHANGHAI HARVEST INTELLIGENCE TECHNOLOGY CO., LTD., Shanghai (CN)

(72) Inventors: Sheng FENG, Shanghai (CN); Fei WANG, Shanghai (CN); Tianyang WANG, Shanghai (CN); Xueke HU, Shanghai (CN); Liyadi ZHANG, Shanghai (CN); Guanyang ZHANG, Shanghai (CN); Jiandong HUANG, Shanghai (CN)

(73) Assignee: SHANGHAI HARVEST INTELLIGENCE TECHNOLOGY CO., LTD., Shanghai (CN)

(21) Appl. No.: 17/283,916

(22) PCT Filed: Nov. 11, 2019
(86) PCT No.: PCT/CN2019/117019

§ 371 Date: Oct. 29, 2021

(30) Foreign Application Priority Data
Nov. 13, 2018 (CN) 201811348933.4

(51) Int. Cl. G06K 9/00; H04N 5/235

(52) U.S. Cl. CPC G06K 9/0004; H04N 5/2351

(57) ABSTRACT

The present invention discloses a topological structure light source driving method, a storage medium and an electronic device applied to off screen imaging. The method includes the following steps of: lighting up pixel points of one or more separate light source regions of a display panel, the light source regions being arranged in a topological structure and spaced by nonluminous pixel points, the light source regions including one or more pixel points; obtaining, through a light sensor, light of pixel points that is totally reflected by a light-permeable cover plate; the display panel and the light sensor are placed under the light-permeable cover plate. Distinguishing from the prior art, the above technical scheme, by one or more pixel points forming one light source, improves the brightness of the light source and enhances the quality of lens-free off-screen optical imaging, while having multiple light sources for image imaging also improves the imaging efficiency.

This application claims priority to Chinese Patent Application No. 201811348933.4, titled “Topological Structure Light Source Driving Method, Storage Medium and Electronic Device Applied to Off Screen Imaging,” filed with China National Intellectual Property Administration on Nov. 13, 2018, the full content of which is incorporated in this application by reference.

### TECHNICAL FIELD

The present invention is related to a technical field of off screen imaging, especially related to a topological structure light source driving method, a storage medium and an electronic device applied to off screen imaging.

### BACKGROUND ART

As information technology develops, biometric identification technology plays a more and more important role in the aspect of ensuring information security, wherein fingerprint recognition has become one of the key technical measures for identity identification and device-unlocking that are widely applied in the field of mobile networking. Under the trend that the screen-to-body ratios of electronic appliances get larger and larger, conventional capacitive fingerprint recognition has failed to meet the requirements, and ultrasonic fingerprint recognition has problems in aspects of insufficient technical maturity, high cost, etc. Therefore, optical fingerprint recognition is gradually becoming a major technical scheme for off-screen image recognition.

Basically, existing schemes for optical fingerprint recognition are all based on principle of geometric optical lens imaging, and fingerprint modules used therein include components such as a micro-lens array and an optical spatial filter, and have many drawbacks such as complex structure, thick module, small sensing range, high cost, etc. Latest research has found that lens-free off-screen optical fingerprint recognition can be realized through principle of total reflection imaging of physical optics, and has advantages such as having simple structure, thin module, large sensing range and low cost in comparison to the existing optical fingerprint scheme. However, ordinary uniform illumination light source cannot meet the need for the principle of total reflection imaging.

### Content of Invention

Therefore, providing a topological structure light source driving method, storage medium and electronic device applied to off screen imaging is needed, in order to solve the problem that ordinary uniform illumination light source cannot meet the need for the principle of total reflection imaging.

To achieve the above purpose, the inventors provide a topological structure light source driving method applied to off screen imaging, comprising the following steps:

lighting up pixel points of one or more separate light source regions of a display panel, the light source regions being arranged in a topological structure and spaced by nonluminous pixel points, the light source regions including one or more pixel points;

obtaining, through a light sensor, light of pixel points that is totally reflected by a light-permeable cover plate; the display panel and the light sensor being placed under the light-permeable cover plate.

Furthermore, the topological structure arrangement is in a single-point arrangement, a multi-point arrangement, a linear arrangement, a parallel-line arrangement, a ring arrangement, a dashed-line arrangement or a parallel-dashed-line arrangement.

Furthermore, a spacing between two adjacent light sources meets a condition that light source total reflection images that are collected by the light sensor do not contact and do not repeat.

Furthermore, the light source region is a circle-like shape, a rectangle, a rhombus, a triangle, a straight line, parallel lines, a dashed line or parallel dashed lines.

Furthermore, wavelength of the color of the light source is 515 nm to 700 nm.

Furthermore, the display panel is a liquid-crystal display, an active-matrix organic light-emitting diode display or a micro light-emitting diode display.

Furthermore, before lighting up pixel points, steps are further included:

performing value-assignment on a matrix that has the same resolution as the display panel by assigning non-zero values to the light source regions and assigning zero to the other regions, and making the matrix that has been assigned values serve as RGB information for generating a display image;

transmitting the display image to the display panel.

Furthermore, steps are further included:

after a preset time interval, performing the same position shifting on all light source regions;

repeating the step of lighting up pixel points and the step of obtaining light again.

The present invention provides a storage medium. The storage medium stores a computer program. The computer program, when executed by a processor, implements the steps of the method as described in any one of the above items.

The present invention provides an electronic device including memory, a processor, an image-acquiring structure. The image-acquiring structure includes a light-permeable cover plate, a display panel and a light sensor. The display panel and the light sensor are placed under the light-permeable cover plate. The processor is connected to the display panel and the light sensor. The memory stores a computer program. The computer program, when executed by the processor, implements the steps of the method as described in any one of the above.

Distinguished from the prior art, the above technical scheme, by forming one light source with one or more separate pixel points, improves the brightness of the light source and enhances the quality of lens-free off-screen optical imaging, while having multiple light sources for image imaging also improves the imaging efficiency.

### DESCRIPTION OF ACCOMPANYING FIGURES

FIG. 1 is a schematic diagram of implementing lens-free off-screen optical fingerprint imaging by the present invention using the principle of total reflection imaging;

FIG. 2 is a flow chart of a method described in an embodiment of the present invention;

FIG. 3 is a schematic diagram of a topological structure of a light source region of a display panel of the present invention;

FIG. 4 is a schematic diagram of another topological structure of a light source region of a display panel of the present invention;

FIG. 5 is a flow chart of another method described in another embodiment of the present invention.

Description of symbols in the accompanying figures:

O: illuminating point,

O′: another illuminating point,

A: contact point between a fingerprint and a light-permeable cover plate,

B, B′: imaging point.

### Specific Implementation Manner

In order to describe the technical content, structural features, achieved goals and effects of the technical scheme(s) in detail, the following provides detailed description in combination with specific embodiments and the accompanying figures.

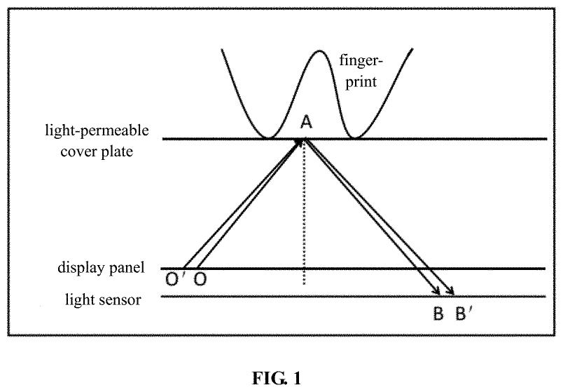

Please refer to FIGS. 1-5. This embodiment provides a topological structure light source driving method applied to off screen imaging. The method is applied to an off-screen imaging structure. As shown in FIG. 1, the off-screen imaging structure includes a light-permeable cover plate, a display panel and a light sensor. The display panel and the light sensor are placed under the light-permeable cover plate.

Specifically, the light-permeable cover plate may be a single-layer plate structure or a multi-layer structure. The single-layer structure may be a cover glass or a cover plate of organic light-permeable material. The single-layer structure may also be a cover plate having other function(s), for example, a touch screen. The multi-layer structure may be multiple layers of cover glass, or multiple layers of cover plates of organic light-permeable material, or a combination of a cover glass with a cover plate of organic light-permeable material. In this specification, the light-permeable cover plate may be referred to as “cover glass,” and these two terms are interchangeable. A person skilled in the art can choose any commercially available cover glass according to the conventional technology, as long as it can realize the technical scheme of the present invention.

The light sensor is used to obtain light, includes multiple light-sensing units, and can be individually disposed under the display panel or disposed on the display panel. When being disposed under the display panel, light can pass through gaps among light sources on the display panel and enter the light sensor. When being disposed on the display panel, the light-sensing units can be disposed in the gaps among the light sources (pixel points) of the display panel. The sensor may be disposed in the off-screen imaging structure for obtaining an off-screen image, for example, for obtaining fingerprints, palm prints, etc. The light-permeable cover plate and the display panel need to be connected by filling optical cement, in order to prevent reflection of the light from being affected by air. The refractive index of the optical cement should be as close to the refractive index of the light-permeable cover plate as possible, in order to prevent total reflection of the light from occurring between the optical cement and the light-permeable cover plate. In this specification, the display panel may be referred to as “light source plate,” and these two terms are interchangeable. A person skilled in the art can choose any commercially available display panel according to the conventional technology, as long as it can realize the technical scheme of the present invention.

The principle of total reflection imaging is that a finger is in contact with the light-permeable cover plate during imaging, the light that has an incident angle exceeding a critical angle of total reflection because of air in recessed portion of the fingerprint will form total reflection and the light sensor will gather bright light, while the fingerprint is protruding and is in contact with an upper surface of the light-permeable cover plate and light will not generate total reflection and thus the light sensor will gather darker light, so that a fingerprint image can be distinguished. During the process of obtaining fingerprint, the finger first presses on a point A on the cover glass, and is therefore imaged onto a point B on a surface of the sensor. According to the condition of total reflection, light emitted by a single illuminating point O on the display panel exactly satisfies the requirement. An ideal light source satisfying the purpose of off screen imaging is preferably a circle-like shape, a rectangle, a rhombus, a triangle, a straight line, parallel lines, a dashed line or parallel dashed lines.

However, there are many constraints that must be considered in practical applications, including that (1) brightness of a single pixel point of an existing display panel is usually not able to satisfy imaging requirements, and that (2) the space under the screen is very small and the range illuminated by a single light source is also very small, so that an acquisition speed is very slow for large-area image acquisition.

First, this embodiment combines one or more pixel points together to form a composite light source, overall brightness of which satisfies the requirement for imaging. The requirement for fast off-screen imaging can only be satisfied by multiple separate light sources co-illuminating the finger simultaneously.

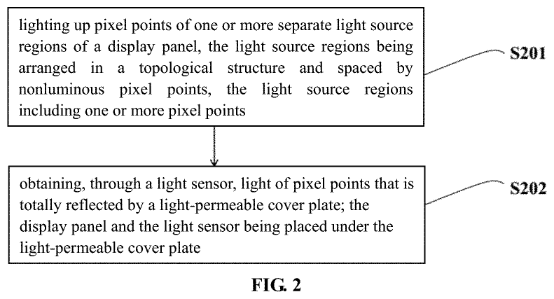

Then, in carrying out driving of the display panel, the driving method includes the following steps. As shown in FIG. 2, step S201, which is a step of lighting up pixel points, is: to light up pixel points of one or more separate light source regions of a display panel. The light source regions are arranged in a topological structure and spaced by nonluminous pixel points. The light source regions include one or more pixel points. Preferably, color of multiple pixel points is the same. Step S202, which is a step of obtaining light, is: to obtain, through a light sensor, light of pixel points that is totally reflected by a light-permeable cover plate; the display panel and the light sensor being placed under the light-permeable cover plate. In this embodiment, one or more separate light source regions can illuminate multiple regions on the light-permeable cover plate, and then light that has been totally reflected by the upper surface of the light-permeable cover plate can be obtained by the light sensor. In this way, images of multiple regions can be obtained, and efficiency of obtaining images is increased. At the same time, the light source regions include multiple pixel points, thereby satisfying the illumination brightness requirement for imaging, so acquisition of images on the light-permeable cover plate can be realized.

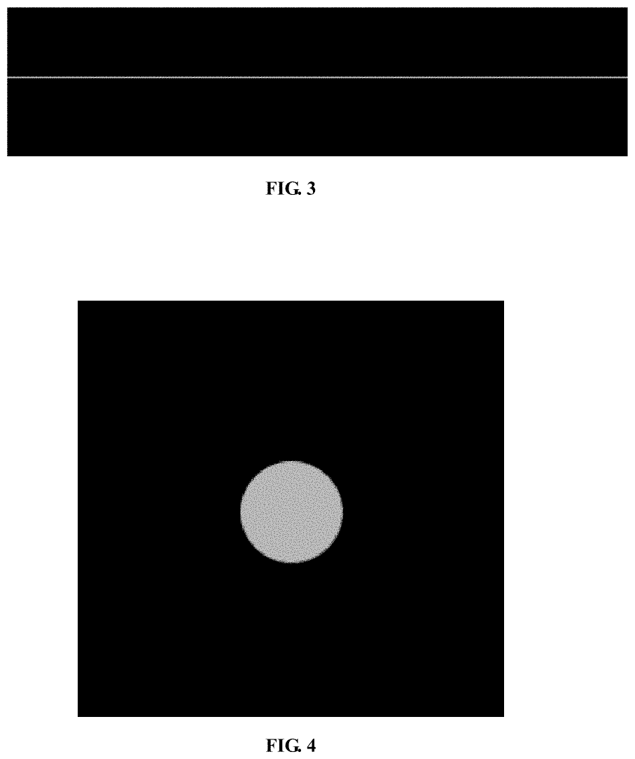

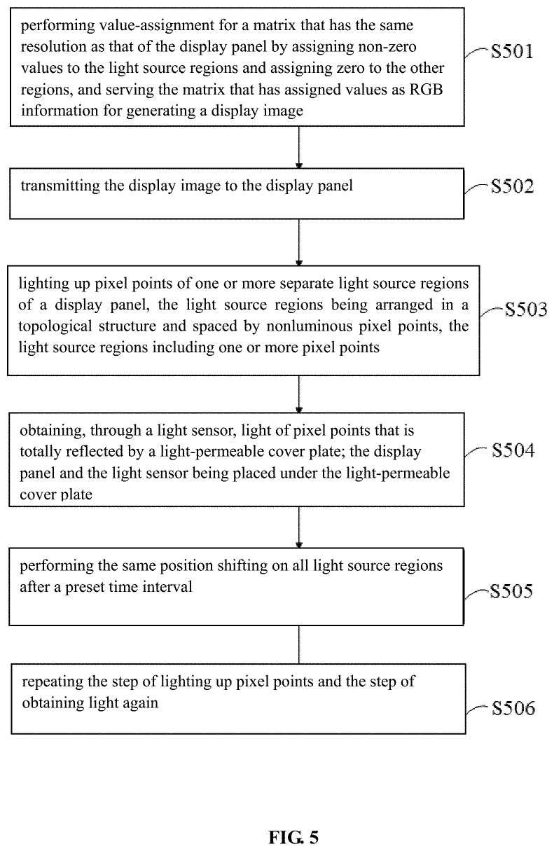

The topological structure arrangement of the light sources in this embodiment can be arranged in multiple ways, preferably uniform arrangement (i.e., distances each between two light sources are equal), so that the reflected image of every light source is the same, which facilitates subsequent image processing. A specific way of the arrangement may be a single-point arrangement, a multi-point arrangement, a linear arrangement, a parallel-line arrangement, a ring arrangement, a dashed-line arrangement or a parallel-dashed-line arrangement. FIG. 3 and FIG. 4, wherein the white color is the light sources illustrate a linear arrangement and a single-point arrangement, respectively.

The spacing between two light sources decides on the imaging quality. This spacing is determined by the spacing between the light source and the upper surface of the cover plate, and these two spacings are positively proportional to each other. In order to prevent overlap between imaging, the interval between two adjacent light sources satisfies a condition that light source total reflection images that are collected by the light sensor do not contact and do not repeat. Preferably, the spacing between the light sources may take a minimum value under the condition that total reflection images of two adjacent light sources do not contact and do not repeat. This minimum value can be obtained through multiple times of manual testing by, for example, obtaining total reflection images of light sources with different spacings of the light sources, and then checking a minimum value of the spacing of the light sources in reflection images satisfying the condition of no contact and no repeat. Afterwards, said minimum value can be preset in memory used to perform the present method. In reality, the spacing of the light sources may be affected by imaging structural hardware parameters of the display panel, the light sensor and the light-permeable cover plate. In practical applications, screen hardware parameters of a product usually do not change, so for these particular screens, adopting multiple manual testing for the attainment is more direct and convenient. In some embodiments, the spacing of the light sources can also be relatively close, so in a single light acquisition, a single light source total reflection image will produce overlap, then the overlap will need to be removed during image processing, and it will increase the workload of each image processing.

As described above, the present invention combines one or more pixel points to form a composite light source with an overall brightness satisfying the requirement for imaging. That is to say, the brightness of the light source has to meet the requirement of being obtainable by the light sensor, and the number of the pixel points and the brightness of the pixel points of the display panel have a linearly and inversely proportional relationship. Also, the shape of the light source affects the presentation quality, and said shape of the light source may be in the form of a circle-like shape, a rectangle, a rhombus, a triangle, a straight line, parallel lines, a dashed line or parallel dashed lines. Preferably, said light source is in a linear arrangement or a single-point arrangement (as shown in FIGS. 3 and 4). Since each pixel is in fact square, a combination of multiple pixels cannot form a standard circle, but only a circle-like shape that is close to a circle. The pixel points of the circle-like shape can be determined by drawing a circle with a certain pixel point serving as the center and using all pixel points inside the circle as pixel points of the circle-like shape. A preset ratio of occupied area can be set for the pixel points on the circumference of the circle, and a pixel point on the circumference is used as a pixel point of the light source circle-like shape if a ratio of an area of the pixel point inside the circle to a total area of the pixel point is greater than the preset ratio of occupied area. The size of the circle determines the light intensity of the light source and whether the light sensor can obtain images with higher quality. If the circle is too small, the light source region is too small and thus the generated light is insufficient. If the circle is too large, the light source region is too large and thus the imaging quality may be affected. Different display panels will also have different light intensity, and thus the size of the light source regions of different display panels will also vary. For a particular image-imaging-capturing structure, the size of the light source region can also be obtained through multiple times of manual testing. The light source regions can be lighted up in an order from small to big in size, and then a smallest light source region that satisfies the imaging quality is manually selected after the light sensor obtains the image data.

In an existing display panel, the light source can be a rectangle formed by a plurality of pixel points with a side length of 2-15.

A preferable color and wavelength of the light source is 515 nm to 700 nm, i.e., green (515 nm to 560 nm), red (610 nm to 700 nm) or any color combination of a color between these two colors and another color; such colors are most sensitive from the perspective of the light sensor, facilitating light acquisition by the light sensor.

A display panel can be used not only as a light source to emit light, but also for displaying images. Display panels include a liquid-crystal display (LCD), an active-matrix organic light-emitting diode (AMOLED) display or a micro light-emitting diode (micro-LED) display, all of which scan and drive a single pixel with a thin-film transistor (TFT) structure. Single driving of the pixel points can be realized, and thus driving of the light source and array display can be realized. Also, light can pass through gaps among the pixel points and then enter into the light sensor.

The topological structural arrangement of the light source in this embodiment can be generated in various ways, for example, drawn by using a drawing software and then displayed by the display panel. However, since the requirement of the precision of a dot array is high and the number of points is relatively great, the drawing efficiency of this manner is low. Alternatively, a manner as shown in FIG. 5 can be used, wherein before step S403 of lighting up the pixel points, the following steps are further included. Step S501: performing value-assignment on a matrix that has the same resolution as the display panel by assigning non-zero values to the light source regions and assigning zero to the other regions, and making the matrix that has been assigned values serve as RGB information for generating a display image. Step S502: transmitting the display image to the display panel. Subsequently, step S503 and step S504 that are the same as step S201 and S202 are executed. This embodiment takes active-matrix organic light-emitting diode (AMOLED) display (1920×1080 pixels) as an example to illustrate generation of the topological structural arrangement of the light source. A programming language is used with this parameter to design a light source topology structure. The procedure of using the programming language to design the light source topology structure is in fact to assign values to a 1920*1080 matrix (a matrix that has 1920 rows, 1080 columns and all-zero data) by assigning a non-zero value (e.g., 255) to positions that need to be lit up and assigning a value of 0 otherwise, and then to use this matrix as RGB information of an 8-bit image (in the RGB information of an 8-bit image, a datum of 0 represents a black color, and a datum of 255 represents a fully saturated color) to generate a new image. A light source topology structure thus generated is shown in FIGS. 3 and 4, wherein the white color represents the light source. The color of white is used only for graphic illustration, and the color can actually be green or red. Through step S501 and step S502, a required topological structural arrangement of the light source may be generated with high efficiency, and thereby high-speed light source driving may be realized.

Although there is one or more pixel points forming one light source to light up a fingerprint simultaneously, a single imaging still cannot seamlessly scan the whole fingerprint. Using a topological structural arrangement of multiple light sources that are too densely arranged and that are complementary to one other may realize scanning of the whole fingerprint, but the fingerprint images obtained by illumination of individual light source arrays may overlap, making subsequent processing very difficult. In order to avoid overlap, the spacing of the light sources in this application satisfies the condition that images do not overlap. However, in this way, some of the fingerprint images may be lost. In order to obtain a complete fingerprint image, the present invention utilizes time-division multiplexing technology to realize full fingerprint coverage. Specifically, step S505 performs the same position shifting on all light source regions after a preset time interval; step S506 repeats step S503 of lighting up pixel points and step S504 of obtaining light again, until fingerprint images that satisfy a complete fingerprint splicing requirement are obtained. Then, the complete fingerprint image can be obtained after performing noise deduction and splicing on these fingerprint images.

The present invention further provides a storage medium. The storage medium stores a computer program. The computer program, when executed by a processor, implements the steps of the above-mentioned method. The storage medium of this embodiment may be a storage medium disposed in an electronic device, and the electronic device can read the content of the storage medium and realize the effects of the present invention. Further, the storage medium may be an independent storage medium, and by connecting the storage medium and the electronic device, the electronic device is able to read the content in the storage medium and to realize the steps of the method of the present invention. In this way, the method of the embodiment of the present invention can be run on an image-capturing structure to realize the driving of the light sources and the obtaining of off screen imaging.

The present invention provides an electronic device including memory, a processor, an image-acquiring structure. The image-acquiring structure includes a light-permeable cover plate, a display panel and a light sensor. The display panel and the light sensor are placed under the light-permeable cover plate. The processor is connected to the display panel and the light sensor. The storage medium stores a computer program. The computer program, when executed by the processor, implements the steps of the method as described in any one of the above items. The electronic device of this embodiment, by forming one light source with multiple pixel points, improves the brightness of the light source and enhances the quality of lens-free off-screen optical imaging, while having multiple light sources for image imaging also improves the imaging efficiency.

It needs to be made clear that although description with respect to each above-mentioned embodiment has been given in this specification, the patent protection scope of the present invention is not limited thereby. Therefore, based on the novel idea of the present invention, any alteration or modification made to the embodiments described in this specification, or equivalent structure or equivalent flow change that is made by using the content of the specification and the accompanying figures of the present invention, directly or indirectly applying the above-mentioned technical schemes in other related technical fields, are each included in the patent protection scope of the present invention.

1.-11. (canceled)

12. A topological structure light source driving method applied to off screen imaging, characterized by comprising the following steps:
lighting up pixel points of one or more separate light source regions on a display panel, the multiple light source regions being arranged in a topological structure and spaced by nonluminous pixel points, the light source regions including one or more pixel points;
obtaining, through a light sensor, light of pixel points that is totally reflected by a light-permeable cover plate; the display panel and the light sensor being placed under the light-permeable cover plate.

13. The method as claimed in claim 12, characterized in that the topological structure arrangement is in a single-point arrangement, a multi-point arrangement, a linear arrangement, a parallel-line arrangement, a ring arrangement, a dashed-line arrangement or a parallel-dashed-line arrangement.

14. The method as claimed in claim 12, characterized in that a spacing between two adjacent light source regions meets a condition that light source region total reflection images that are collected by the light sensor do not contact and do not repeat.

15. The method as claimed in claim 14, characterized in that the spacing between the two adjacent light source regions takes a minimum value under the condition that the total reflection images of the two adjacent light source regions do not contact and do not repeat.

16. The method as claimed in claim 12, characterized in that the light source region is a circle-like shape, a rectangle, a rhombus, a triangle, a straight line, parallel lines, a dashed line or parallel dashed lines.

17. The method as claimed in claim 12, characterized in that wavelength of the color of the light source is 515 nm to 700 nm.

18. The method as claimed in claim 12, characterized in that the display panel is a liquid-crystal display, an active-matrix organic light-emitting diode display or a micro light-emitting diode display.

19. The method as claimed in claim 12, characterized by, before lighting up pixel points, further comprising steps of:
performing value-assignment on a matrix that has the same resolution as the display panel by assigning non-zero values to the light source regions and assigning zero to the other regions, and making the matrix that has been assigned values serve as RGB information for generating a display image;
transmitting the display image to the display panel.

20. The method as claimed in claim 12, characterized by further comprising steps of:
after a preset time interval, performing the same position shifting on all light source regions;
repeating the step of lighting up pixel points and the step of obtaining light again.

21. A storage medium, characterized by: the storage medium storing a computer program, the computer program, when executed by a processor, implementing the steps of the method as described in claim 12.

22. An electronic device, characterized by: including memory, a processor, an image-acquiring structure, the image-acquiring structure including a light-permeable cover plate, a display panel and a light sensor, the display panel and the light sensor being placed under the light-permeable cover plate, the processor being connected to the display panel and the light sensor, the memory storing a computer program, the computer program, when executed by the processor, implementing the steps of the method as described in claim 12.

23. A storage medium, characterized by: the storage medium storing a computer program, the computer program, when executed by a processor, implementing the steps of the method as described in claim 13.

24. A storage medium, characterized by: the storage medium storing a computer program, the computer program, when executed by a processor, implementing the steps of the method as described in claim 14.

25. A storage medium, characterized by: the storage medium storing a computer program, the computer program, when executed by a processor, implementing the steps of the method as described in claim 15.

26. A storage medium, characterized by: the storage medium storing a computer program, the computer program, when executed by a processor, implementing the steps of the method as described in claim 16.

27. A storage medium, characterized by: the storage medium storing a computer program, the computer program, when executed by a processor, implementing the steps of the method as described in claim 17.

28. A storage medium, characterized by: the storage medium storing a computer program, the computer program, when executed by a processor, implementing the steps of the method as described in claim 18.

29. A storage medium, characterized by: the storage medium storing a computer program, the computer program, when executed by a processor, implementing the steps of the method as described in claim 19.

30. A storage medium, characterized by: the storage medium storing a computer program, the computer program, when executed by a processor, implementing the steps of the method as described in claim 20.

31. An electronic device, characterized by: including memory, a processor, an image-acquiring structure, the image-acquiring structure including a light-permeable cover plate, a display panel and a light sensor, the display panel and the light sensor being placed under the light-permeable cover plate, the processor being connected to the display panel and the light sensor, the memory storing a computer program, the computer program, when executed by the processor, implementing the steps of the method as described in claim 13.
